(19) United States
(12) Patent Application Publication
(10) Pub. No.: US 2008/0008911 A1
(43) Pub. Date: Jan. 10, 2008

(54) Designs of fuel cell electrode with improved mass transfer from liquid fuels and oxidants

(76) Inventors: Abraham Duncan Stroock, Ithaca, NY (US); Joseph David Kirtland, Ithaca, NY (US); Donald Lyle Koch, Willseyville, NY (US); Hector D. Abruna, Ithaca, NY (US)

Correspondence Address: WILSON SONSINI GOODRICH & ROSATI, 650 PAGE MILL ROAD, PALO ALTO, CA, 94304-1050, US

(21) Appl. No.: 11/800,436

(22) Filed: May 3, 2007

Related U.S. Application Data
(60) Provisional application No. 60/797,436, filed on May 3, 2006.

(51) Int. Cl. H01M 8/04; H01M 4/86

(52) U.S. Cl. 429/13; 429/27

(57) ABSTRACT

Methods and apparatus for improving mass transfer in microfluidic laminar stirring structures. The structures include a pair of opposite planar surfaces each configured with a series of dual-chevron grooves. Each series of grooves may include a preselected number of individual grooves that can be substantially identical to each other within each series. One or more series of such dual-chevron grooves may be consecutively formed along a planar surface which constitutes one cycle. Each planar surface may be an electrode layer within a fuel cell structure whereby laminar flows fuel or oxidant are directed past the grooved surfaces to induce stirring. In a preferable embodiment of the invention, a symmetrical stirred structure is provided wherein each of a pair of top and bottom layers are formed with dual-chevron grooves which are symmetrical and mirror images of each other. Increased rates of mass transfer at the boundary layers in proximity to the electrodes and other benefits over current membraneless mixing cell structures are provided.

### CROSS-REFERENCE

This application claims the benefit of U.S. Provisional Application No. 60/797,436, filed May 3, 2006, which application is incorporated herein by reference in its entirety.

The invention was made at least in part with the support of a grant from the Government of the United States of America, Department of Energy (DE-FG02-05ER46250). The Government may have certain rights to the invention.

### FIELD OF THE INVENTION

The invention relates to systems and methods for laminar mixing of flowing fluids. More particularly, the invention relates to stirring fluids to control rates of mass transfer between streams of fluid and between fluid and solid boundaries.

### BACKGROUND OF THE INVENTION

Mixing structures referred to as mixers are known in the art for various applications such as the mixing of chemicals in industrial processes, mixing multi-part curing systems in adhesives, foams and molding compounds, mixing fuels and gases for combustion, mixing air into water for sewerage treatment, or wherever mixing of materials is desired. The mixing of materials often involves combining different flows of fluids relative to each other. Generally, there are two basic types of fluid flow which are referred to as laminar flow and turbulent flow. With respect to laminar flow, a fluid flows in relatively smooth layers or lamina. This occurs when adjacent fluid layers slide smoothly over one another with mixing occurring between layers or lamina predominantly on a molecular level by diffusion. Meanwhile, turbulent flow is characterized by fluctuations of the velocity of the fluid in both space and time. The mixing of two or more substances in turbulent flow conditions generally proceeds faster than under laminar flow conditions. The viscosity, the flow rate, and the density of the fluid along with the diameter of the flow path are known to dictate the type of fluid flow achieved. The more viscous materials are, or the smaller the cross-sectional dimension of the channel in which they flow, the higher the flow rate is required in order to create a turbulent flow. These variables can be considered as part of a dimensionless parameter often used to characterize the flow called the Reynolds number (Re).

Laminar flow conditions are more often desired for certain applications such as the operation of fuel cell structures. Under these conditions, the membrane based processes previously used with separated flows of fuels and oxidants within a cell structure can be replaced by designs incorporating co-flowing laminar flows of these materials. Parallel streams of fuels/oxidants in direct contact with each other intermix with each other across a diffusive boundary layer within a common microchannel. It has been demonstrated that a virtual membrane exists between two fluids under flow conditions in which the fluid dynamics is viscosity-dominated and thus flows are laminar (non-turbulent), and diffusion is slow relative to convection (NPP 1). Formally, this condition is expressed as being of low Reynolds (Re=UH/ν<10³) number and high Péclet number (Pe=UH/D>>1) (NPP 2). Here, U [m/s] is the average flow speed, H is the characteristic dimension of the flow cell, ν [m²/s] is the kinematic viscosity of the fluid, and D [m²/s] is the diffusivity of the solute of interest. This low Re/high Pe condition is easily achieved in microfluidic systems (10 μm<H<1 mm). Under these conditions, mixing of the two solutions only takes place via slow inter-diffusion between laminar streams. This situation allows two fluid streams to move in parallel with a controllable, small degree of intermixing. These co-flowing streams define distinct, yet diffusively coupled, chemical environments that can be exploited in a variety of applications such as electrochemistry (NPP 3-7), microfabrication (NPP 1,8), and chemical separations (NPP 9,10).

FIG. 1 illustrates co-flowing laminar streams in a known fuel cell structure that may be referred to as a planar membraneless microfluidic fuel cell (PM²FC). The PM²FC may include selected co-flowing laminar streams of a fuel and an oxidant (NPP 5,6). In part (A), a schematic diagram of a cross-sectional view of the PM²FC is provided. In part (B), a finite difference calculation of concentration profiles is shown from the perspective of two separate orthogonal cross-sections of the PMFC in part (A). A reagent is injected in the place of a fuel shown in part (A), and can be seen reacting instantaneously at a bottom boundary. The reagent is also shown diffusing passively across the “virtual boundary” that separates the two co-flowing streams. The calculated concentration profiles in part (B) show the diffusion of a species (e.g., fuel) across the virtual membrane. A greater extent of passive diffusion across the virtual boundary is evident further downstream from the co-flowing laminar streams as illustrated in the profiles in part (B).

FIG. 2 illustrates a Staggered Herringbone Mixer (SHM) configured with a PM²FC cell design. In part (A), a schematic diagram and corresponding fluorescent confocal micrographs are provided to show the evolution of two fluorescent streams and one non-fluorescent stream of fluids. In part (B), a series of fluorescent confocal micrographs are provided showing achievement of homogenization in within 3 cm segment of a microchannel at a Pe=10⁶. Without mixing, a comparable degree of homogenization would have occurred in a section within the cell>10 m.

The SHM design shown in FIG. 2 can be adapted for homogenizing chemical gradients within the bulk of a laminar flow in a microchannel. The particular strengths of an SHM system for applications in electrochemical mass transfer include: 1) simplicity of fabrication and compatibility with a variety of materials, including those employed in the PM²FC, 2) exponential mixing due to nearly uniform chaotic nature of the flow (NPP 11), 3) appropriateness for mixing in flows with a wide range of Reynolds numbers (0≦Re<100), and in particular in the Stokes regime (Re<1) that is common in microfluidic flows, and 4) ability to selectively mix sub-regions of the flow while leaving others unperturbed, such that the fluid adjacent to the electrode can be stirred without perturbing the virtual interface. All of these characteristics are valuable for increasing current density, power, and fuel efficiency in the context of the PM²FC.

FIG. 3 provides a schematic diagram of a SHM and a lid-driven cavity model of the flow in such a structure. In part (A), one cycle of the SHM pattern is illustrated. Grooves along the floor induce transverse secondary flows when a steady pressure gradient is applied along the channel. In part (B), a lid-driven cavity approximation of the SHM is illustrated. Transversely (along x) slipping regions on a smooth boundary generate transverse flows that mimic those induced by grooves. In part (C), a series of streamlines of cross-sectional flow are illustrated which are produced by lid-driven cavity approximation of the SHM. The degree of asymmetry r and the half-cycle length L_{1/2} can be tailored to produce regular or chaotic flow. In part (D), local Sherwood number Sh(z) is plotted as a function of axial distance. Sh(z) is graphically illustrated as a function of axial distance scaled by Pe. The following symbol shapes shown in part (D) indicate the value of Pe: circle—10², square—10³, diamond—10⁴, triangle—10⁵. Open symbols are unstirred, filled symbols are chaotically stirred, r=⅓, L_{1/2}=10H, and uₜᵣₐₙₛ/U=0.2.

Numerous challenges are presented in optimizing the operation and function of membraneless cell processes. The same conditions of low Re and high Pe that make the membraneless-design feasible also pose multiple challenges with regards to optimizing the transport of electro-active species in membraneless fuel cells: (1) Transport limited current density: The laminar (non-turbulent) character of the flow allows concentration boundary layers to grow unperturbed above the electrodes; diffusive transport across these boundary layers limits the current when electrode kinetics are fast; (2) Compromised fuel efficiency: In order to achieve high current densities and power in a transport-limited regime, flow speeds (and Pe) must be high enough to maintain thin boundary layers; this situation leaves much of the fuel outside the boundary layer and thus unused; 3) Requirement of selective mixing: Due to the lack of a physical membrane, any mixing strategy that is used to enhance mass transfer to the electrodes must be designed to act selectively at the electrode surface and not mix across the virtual membrane. It has been observed that electrode reactions pose an inherent challenge for mass transfer in that species must be delivered to a stagnation region in the flow created by the no-slip condition at the electrode surface.

### SUMMARY OF THE INVENTION

The invention provides methods and systems to provide symmetrical laminar stirring for improving mass transfer in membraneless microfluidic devices. Alternative embodiments of the invention also provide or include microfluidic devices that are formed with membranes or physical barriers. It shall be understood that various embodiments of the invention described herein can be applied individually or in combination with other aspects of the invention.

One aspect of the invention provides chaotic laminar mixing structures for microfluidic applications. This can offer an important tool for controlling mass transport limitations to electrodes which can result in a high performance, micro-integrated fuel cell (e.g., hydrogen/oxygen). The aforementioned limitations and other drawbacks of current devices are overcome by the invention in part at least by implementing a laminar mixing strategy that is based on combination of a Staggered Herringbone Mixer (SHM) design within a Planar Membraneless Microfluidic Fuel Cell (PM²FC). While the SHM may be recognized as a highly efficient and versatile type of passive mixer configuration developed for microfluidic applications (NPP 11-13), preferable embodiments of the invention further enhance and improve upon this design in order to provide increased rates of mass transfer from chaotic flows to no-slip reactive boundaries. A theoretical study of problems associated with mass transfer at reactive boundaries has been done which can highlight the advantages provided by the invention herein (NPP 14).

Other aspects of the invention provide microfluidic laminar stirring structures that include a pair of opposite planar surfaces each configured with a series of dual-chevron grooves. Each series of grooves may include a preselected number of individual grooves that can be substantially identical to each other within each series. One or more series of such dual-chevron grooves may be consecutively formed along a planar surface which constitutes one cycle. The planar surface may be an electrode layer within a fuel cell structure. In a preferable embodiment of the invention, a symmetrical stirred structure is provided wherein each of a pair of top and bottom layers are formed with dual-chevron grooves which are symmetrical to one another (top and bottom are mirror images of each other). An embodiment of the invention includes a fuel cell structure having co-flowing laminar flows passing over the symmetrically grooved surfaces of a top electrode and a bottom electrode. These and other embodiments provide increased rates of mass transfer at the boundary layers (electrodes) and other benefits over current membraneless mixing cell structures.

A preferable embodiment of the invention provides three-dimensional conducting structures formed on electrode surfaces within an electrochemical cell. These conducting structures or series of chevron-shaped grooves, which are symmetrically or non-symmetrically formed on opposing surfaces of two planar electrodes, can be designed to generate three-dimensional secondary flows in one or more fluids preferably driven by pressure gradients over each electrode. A characteristic of these structures and their functions include the creation of secondary flows which increase the rates of mass transfer for the flowing solution to the surface of the electrodes. For fuel cell applications, this can lead to generating higher currents, greater power generated and increased fuel efficiencies. At the same time, another benefit provided in accordance with this embodiment of the invention generates localized disturbances in the flow within the fuel or fluid cell structure such that increased rates of mass transfer can be achieved locally without global mixing, which is an important consideration and often undesired in membraneless fuel cell apparatus. The series of grooved surfaces formed along each opposing side of the electrode or boundary walls within the flow cells provided herein promote symmetrical stirring and are passive structures. There are no moving parts required for such cells provided in accordance with the invention which greatly simplifies related operational and manufacturing processes.

Another aspect of the invention provides methods of manufacturing fuel cell electrodes or flow cell walls having opposing three-dimensional grooved structures which improve mass transfer between parallel flowing fluids therein such as liquid fuel and oxidant streams. These structures can be manufactured according to available techniques often employed in the semiconductor industry such as microlithography and thin layer deposition techniques.

There are notable differences and similarities between the known geometry shown in FIG. 3 and that disclosed with certain embodiments of the invention: 1) the reactive boundary is distinct from the topographically patterned boundary in the study represented in FIG. 3. 2) There is only one topographically patterned boundary in this geometry whereas there are two patterned boundaries in the symmetrically stirred geometry in this invention. Despite these differences, the flux to the patterned boundary in the symmetrically geometry described here may show similar behavior, including a rapid transition to a constant value of Sh that will scale with Pe. The fluxes will be higher in the case when the reactive boundary is structured because the local shear rate, \dot{γ}ₜᵣₐₙₛ, will be higher.

A preferable geometry for symmetrically stirred laminar flows provided in accordance with the invention may be analogous to the one half (either the top or bottom) of a current PM²FC design (see FIG. 3). The role of laminar mixing on mass transfer to boundaries can be characterized so as to demonstrate some of the benefits of the cell structure geometries provided by the invention. Simulations indicate that three-dimensional (3-D) laminar flows of all types lead to increased rates of mass transfer to reactive boundaries in microchannels relative to uniaxial flows. Part (D) of FIG. 3 plots the evolution of the Sherwood, Sh=kH/D, number with the axial distance down the channels at different values of the Peclet number. In the definition of Sh, k [m/s] is the local mass transfer coefficient. The mass transfer coefficient is related to the local flux, J [moles/(m²s)] and the concentrations, c [moles/m³] of reactant as follows: k=J/(c_{surface}−c_{average}), where c_{surface} and c_{average} are the concentration of the reagent at the surface and velocity weighted average of the concentration in the flowing fluid. [Bird, 1960 #99] By comparing several flows, the characteristics of a flow were identified that are important for increasing mass transfer to boundaries: 1) a high transverse shear rate near the reactive boundary; this property is of high importance to increase the average rates of transfer relative to those from uniaxial flows, and 2) the ability to homogenize the concentration boundary layer before it returns to the reactive boundary; this characteristic leads to a simple evolution of Sh as is shown in part (D) of FIG. 3. In particular, Sh reaches an asymptotic values of the following form:

$$\begin{matrix}{Sh}_{plat} = \frac{{( 3 / 4 )}^{1 / 3}}{Γ ( \frac{4}{3} )} {( \frac{H}{W} )}^{1 / 3} {( \frac{{H}^{2} {\dot{γ}}_{trans}}{D} )}^{1 / 3} \\ = 1.02 {( \frac{H}{W} )}^{1 / 3} {( \frac{H {\dot{γ}}_{trans}}{{u}_{trans}} )}^{1 / 3} {( \frac{{u}_{trans}}{U} )}^{1 / 3} {Pe}^{1 / 3}\end{matrix} \qquad ( 1 )$$

for axial distances, z>zₘₐₓ˜W(U/uₜᵣₐₙₛ). Here, uₜᵣₐₙₛ is the transverse velocity generated by the topography and \dot{γ}ₜᵣₐₙₛ is the shear rate related to this transverse flow at the reactive boundary. The existence of this second property appears to distinguish chaotic 3-D flows from non-chaotic ones: chaotic advection appears to be both necessary and sufficient to ensure the complete homogenization of the depleted solution before returning it to the reactive surface. It shall be understood that concepts of the invention may be applied to the various apparatus and methods available today that are based on membraneless laminar co-flowing cell technology.

With respect to yet another embodiment of the invention, any of the membraneless microfluidic structures and fuel cells described herein can be modified to also include a physical barrier or membrane. Even in the presence of a membrane, such systems provided are also compatible with chaotic stirring and exhibit many of same characteristics and benefits as noted for the membraneless embodiments of the invention.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference in their entirety to the same extent as if each individual publication, patent or patent application was specifically and individually indicated to be incorporated by reference.

### BRIEF DESCRIPTION OF THE DRAWINGS

The illustrations included within this specification describe many of the advantages and features of the invention. It shall be understood that similar reference numerals and characters noted within the illustrations herein may designate the same or like features of the invention. The illustrations and features depicted herein are not necessarily drawn to scale.

FIG. 1 illustrates co-flowing laminar streams in a planar membraneless microfluidic fuel cell.

FIG. 2 includes a schematic diagram of a staggered herringbone mixer and resulting fluorescent confocal micrographs corresponding to the mixer.

FIG. 3 show a schematic diagram and corresponding graphs for a staggered herringbone mixer formed grooves along the floor of the mixer.

FIG. 4 provides a schematic diagram and axial cross-sectional views of a microfluidic device that can be configured as a planar membraneless microfluidic fuel cell in accordance with an embodiment of the invention.

FIG. 5 include illustrations from various views of microfluidic devices that can be adapted as planar membraneless microfluidic fuel cells which are formed with grooved electrodes or a pair of electrodes with a plurality of grooves formed thereon according to an embodiment of the invention.

FIG. 6 is a series of diagrams illustrating another aspect of the invention for fabricating device walls or surfaces with grooves by isotropic etching.

FIG. 7 is a series of diagrams illustrating another aspect of the invention for fabricating device walls or surfaces with grooves following an electrode evaporation and lift-off process.

FIG. 8 is a scanning electron micrograph of herringbone grooves formed in glass according to an alternate embodiment of the invention.

FIG. 9 are optical and fluorescence micrographs for a mixing structure formed in accordance with an embodiment of the invention that includes a series of grooves shown with four units in a staggered herringbone mixer running side-by-side.

FIG. 10 provides a side-by-side comparison of fuel cells formed with conventional flat electrodes and fuel cells formed with chaotic electrodes.

FIG. 11 is a schematic diagram of a planar micro fuel cell or flow structure that includes a physical barrier or membrane.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

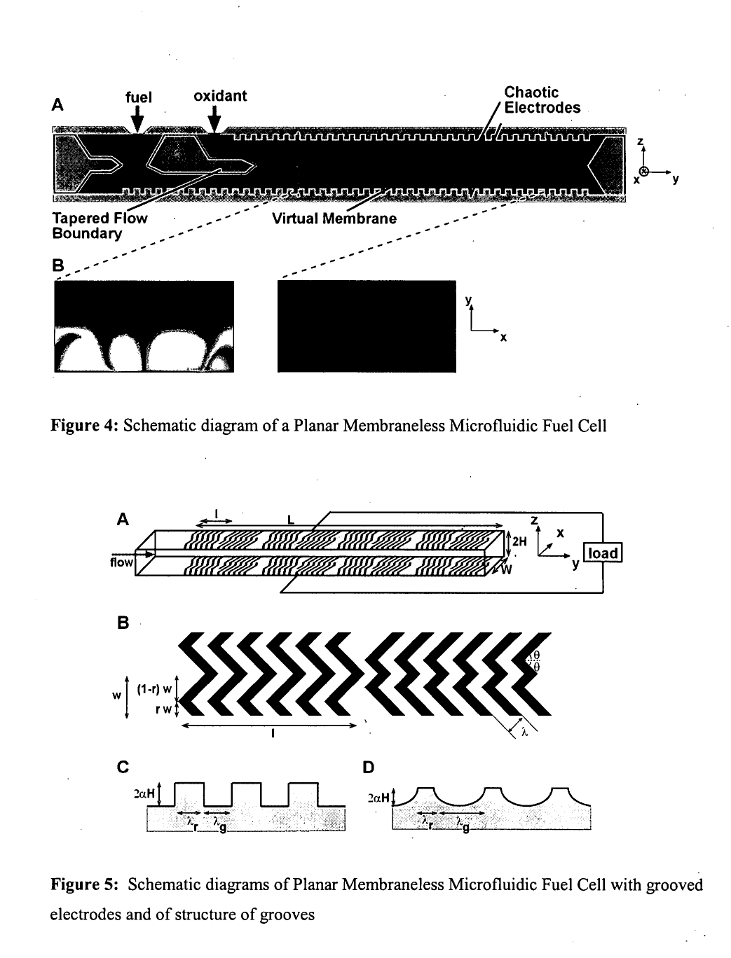

FIG. 4 is a schematic diagram of a Planar Membraneless Microfluidic Fuel Cell (PM²FC) provided in accordance with an embodiment of the invention. In part (A), a lateral cross-sectional view is illustrated showing the injection of an oxidant flow and a fuel flow. In part (B), axial cross-sectional views are provided which depict the evolution of the distribution of fuel stream in the flow generated by the chaotic electrodes, as calculated numerically. A greater extent of passive diffusion across the virtual boundary is evident further downstream from the co-flowing laminar streams as illustrated in part (B). The distribution of oxidant (not shown) evolves in a mirror image flow in the top half of the cell. The fuel cells provided herein can incorporate fuel/oxidants within single electrolyte systems or dual electrolyte systems including those described in U.S. patent application Ser. No. 11/285,509 which is incorporated by reference herein in its entirety.

FIG. 5 are schematic diagrams of another modified PM²FC provided in accordance with another embodiment of the invention having grooved electrodes or a structure with formed grooves. In part (A), a diagram is provided showing a perspective view of the PM²FC wherein the electrodes are indicated by shading. The grooves formed in each of the electrodes are indicated by heavy black lines. The average height of the flow chamber may be defined as 2H. The width of the flow cell can be defined as W. The total length of the flow cell may be defined as L. The length of one half cycle of the grooved pattern as illustrated also can be defined as l. As shown in part (B), which is a top view of a pattern of grooves, the pair of opposite facing electrodes can be modified to generate three dimensional (3-D) flows in a PM²FC. This pattern may be considered an enhanced design that is based upon the current Staggered Herringbone Mixing (SHM) structures. The patterned surface of a relatively top electrode layer may be constructed with a mirror image pattern in comparison to the opposite facing surface of a relatively bottom electrode layer as shown. The pattern shown may be defined as one cycle of the SHM mixer with two units of the mixer running side-by-side. The width of one unit of the mixer is w. The fractional width filled by the short arm of the herringbone is r. In comparison to current PM²FC designs, each groove in a pattern provided herein may include two peaks or dual-chevrons rather than just a single peak or single chevron design (see FIG. 2). Each series of grooves as shown in FIG. 5 may include one or more series of identical grooves. A different pattern of grooves may exist within each adjacent or consecutives series of such grooves which define a cycle. The length of a half cycle is l, as shown in part (A). The period of the grooves is, λ. The angle of the grooves with respect to the axial direction is, θ. As shown in parts (C) and (D), which are side views of grooves cut along a plane that runs normal to the length of the grooves and ridges, the grooves may be formed with relatively straight or perpendicular peaks and valleys and/or as a series of dips or curved valleys. The depth of the grooves is 2αH, where H is the total height of the flow cell and α is the relative height of the grooves to the height of the flow cell. The width of the ridges is λᵣ and the width of the grooves is λ_{g}. The grooves shown in part (C) may be typical of those formed by soft lithography based on SU-8 negative photoresist and by anisotropic etches of silicon. The grooves shown in part (D) may on the other hand be typical of those formed by isotropic etches of glass. It shall be understood that other groove configurations may be selected in accordance with the invention and made from other methods of manufacturing known to those of ordinary skill in the field.

Symmetrically Stirred Membraneless Devices

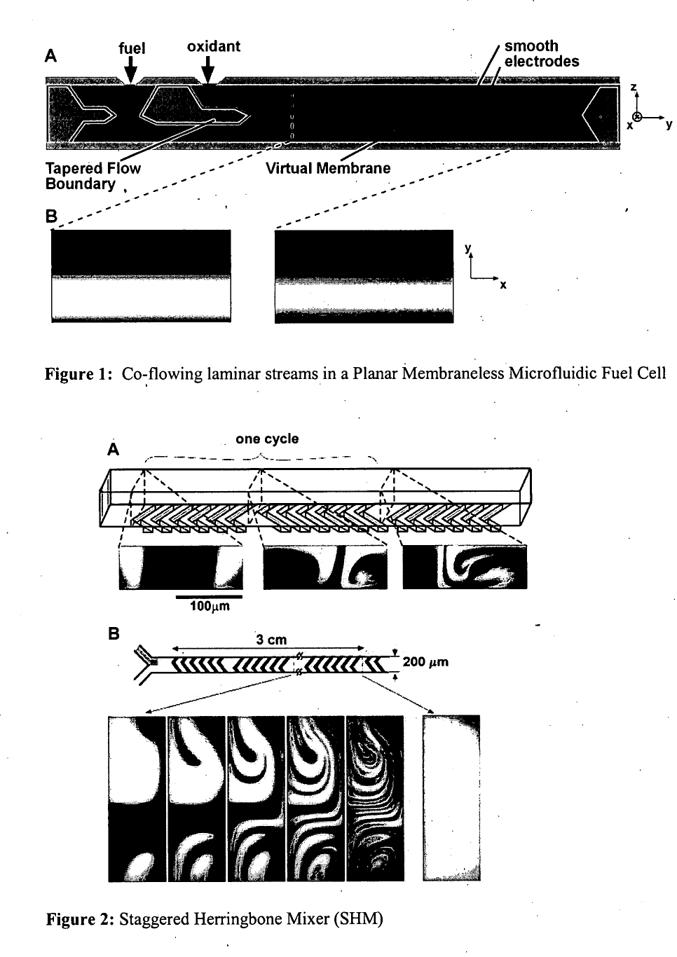

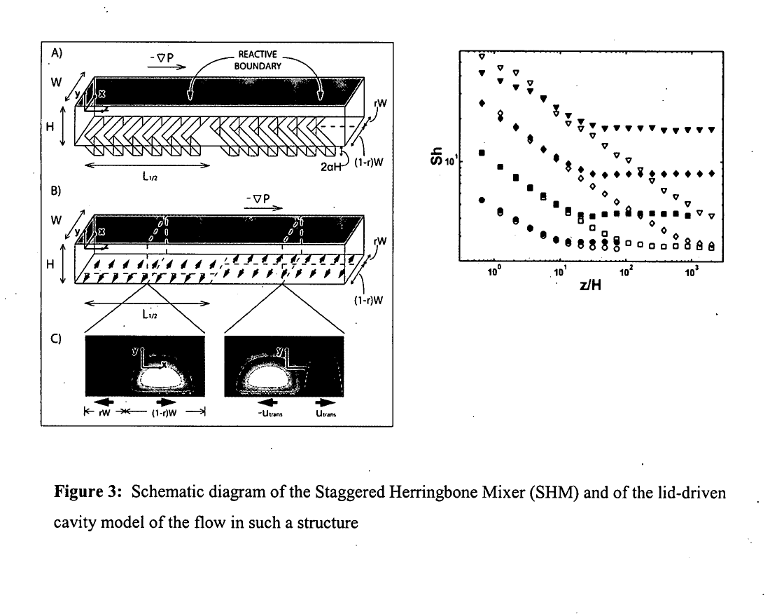

FIGS. 4 and 5 illustrate alternative designs and methodologies for providing symmetrically stirred laminar flows within a membraneless device. The invention may be described herein with reference to all figures in the following discussion using the conventional PM²FC design as an example to which improvements can be made. For example, a conventional PM²FC design as shown in FIG. 1 may be modified in accordance with the invention to provide a preferable embodiment shown in FIG. 4 wherein the addition of grooves is accomplished on both the top and bottom walls of the cell structure. The frames in part (B) of FIG. 4 show the results of a calculation of the evolution of the concentration of the fuel in an approximate representation of the flow generated by a staggered herringbone pattern of grooves in both the top and bottom boundary. The structure of the grooves modeled by this calculation can be selected as shown in more detail in FIG. 5.

An important operation of the symmetrical laminar co-flow designs provided in accordance with this aspect of the invention is to generate three-dimensional flow within a flow cell in order to increase rates of mass transfer to the top and bottom walls (boundary layers). Another function of is to create a particular class of 3-D flows that should not carry fluid across the horizontal plane that bisects the flow cell (e.g., the virtual membrane or the xy-plane at z=0 in FIG. 5A). This effect is illustrated in the frames in part (B) of FIG. 4. Stirring occurs within the top and bottom half of the cross-section, but preferably no streams cross the mid-plane.

Some of the relevant features of the designs provided herein that can be applied to current membraneless cell structures include the following: 1) a flow chamber with a pair of parallel top and bottom walls in which a surface topography (as shown in FIG. 2) can be created on each that is symmetrical and facing each other (mirror images), 2) the incorporation of identical topography in the top and bottom walls in substantially all or any selected portion or part of the flow cell in which there is no obstruction, e.g., the tapered flow boundary, between the top and bottom wall; wherein each topographical feature, e.g., groove, single chevron groove, in a top or bottom boundary is preferably matched by an identical feature in the other boundary in a manner that substantially ensures mirror symmetry with respect to the plane the horizontal plane that bisects the flow cell (the xy-plane at z=0, with the axes defined in part (A) of FIG. 5. Thus, each depression in a ceiling of a flow cell is preferably aligned with an identical depression in a floor of the flow cell, and the same holds true for each protrusion, and 3) the topography in a top boundary and a bottom boundary are preferably designed to induce net transverse components (along x and y) in a pressure driven flow down the axial dimension of the flow cell (along z). Obliquely (θ≠0 or 180°) oriented grooves and ridges in patterns such as that shown in part (B) of FIG. 5 may be preferable or appropriate for this purpose. The angle θ and the shape of the grooves (the relative depth, α and the period, λ are relatively more important) and can define the relative strength of the transverse components of the flow relative to the axial flow. The influence of different geometrical factors on the strength of a transverse flow has been discussed and described in a previous publication (NPP 13).

It should be noted that there exists a limitless number of distinct topographical patterns that may increase rates of mass transfer to the top and bottom boundaries of a flow cell in accordance with the invention herein. Any of these boundary surface patterns could be made to be compatible for use in membraneless flow cell with a virtual membrane by implementing it with an appropriate top-bottom mirror symmetry. As described elsewhere herein, current boundary surface pattern may be applied to this aspect of the invention, or preferably a symmetrical boundary surface can be provided having dual-chevron grooves to improve mass transfer to the boundaries of flow cell apparatus and their relates methods of operation. It should be further noted also that a selected topography herein that does not generate net transverse flows would still likely have some beneficial effect on rates of mass transfer nonetheless, in that such topography could increase the surface area of the reactive boundaries relative to a flat design.

Preferable Specifications of Symmetrically Stirred Flow Cell Designs and Their Operation:

1) Alignment of topography on top and bottom. This alignment is preferably better than one period of the topography, λ.

2) Cell geometry: The global dimensions of the flow cell (H, W, and L) are not restricted except for the preference the flows within the cell remain laminar (non-turbulent−Re=UH/ν<2000). Reasonable ranges: 10⁻⁶ m<H, W, L<1 m.

3) Topographical geometry: Typically, the depth, αH, and period, λ, (or typical lateral extent) is preferably less than or equal to the half-height of the flow cell, H. Other topographical considerations are discussed elsewhere herein. Reasonable range: 10⁻⁷ m<λ<1 m; 0.01<α<1.

4) Flows: The flows speeds is preferably slow enough that the flows remain laminar (non-turbulent−Re=UH/ν<2000).

Fabrication:

A preferable fabrication procedure is provided herein to manufacture flow cell structures in accordance with another aspect of the invention, namely a photolithography process followed by wet etching of glass and metallization by evaporation of metals. This preferable manufacturing technique can be used to create reactive boundaries for fuel cell applications with a desired or appropriate topography. It should be understood however that any of a number of other microfabrication processes could be used, such as mechanical machining, soft lithography, dry chemical etching, or electroplating. For example, parts (C) and (D) in FIG. 5 show the cross-sectional profiles of two types of topography that are commonly achieved by these and other known fabrication procedures. Both types of illustrated shapes (rectilinear and rounded) may be acceptable for application of the invention.

The fabrication of laminar flow based fuel cells incorporating symmetrically stirred streams in accordance with this aspect of the invention can be described as involving three main steps: etching of the mixing structures into glass, metallization of the glass to form electrodes and contacts, and fabrication of a gasket to define the flow channel between the electrodes.

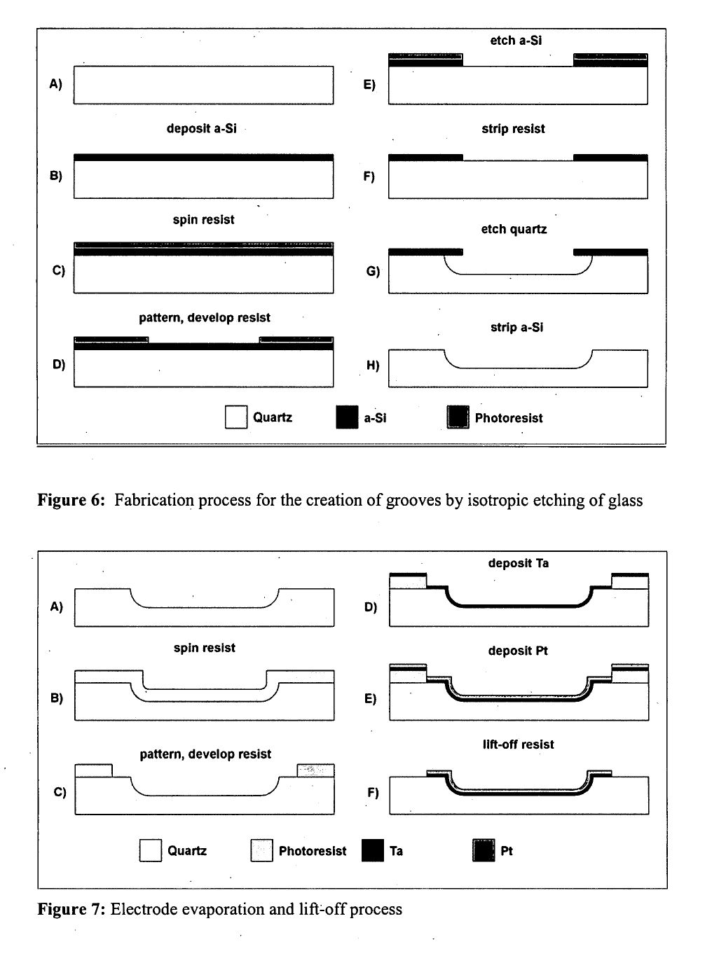

FIG. 6 illustrates a preferable fabrication process for the creation of grooves by isotropic etching of glass. A mixing structures according to this process can be created by etching herringbone shaped grooves which are described elsewhere herein (see FIG. 5) into quartz wafers (4″, 750 micron thick, Mark Optics). This process can be accomplished as follows as depicted in FIG. 6: A) a quartz (glass) surface is first cleaned with hot piranha (H₂SO₄, H₂O₂) in order to remove residual organics and contaminants, B) a hard mask (˜400 nm) of amorphous silicon (a-Si) is deposited by plasma enhanced chemical vapor deposition (PECVD) onto the quartz in a load locked GSI PECVD system, C) & D) a layer of photoresist (Shipley 1818, ˜2 microns thick) is spun and patterned on an EVG 620 contact aligner to define the windows in the a-Si mask through which the grooves will be etched, E) an SF₆/O₂ reactive ion etch is used to etch through the a-Si in the pattern left by the developed photoresist, F) after stripping the photoresist, G) the underlying quartz (glass) is etched isotropically to the desired depth in hydrofluoric acid (HF) or buffered oxide etch (BOE, 6:1 NH₄F:HF). The resulting grooves are smooth and essentially cylindrical or spherical due to the isotropic undercut of the etch, and H) the a-Si mask is stripped in hot potassium hydroxide (KOH) leaving only the underlying quartz with 50 micron deep grooves (see parts (B) and (C) of FIG. 5).

Alternatively, additional processing steps may be followed to modify or metallize the surfaces of the electrode plates described above and elsewhere herein. For example, upon etching or otherwise forming the mixing structures onto the surfaces of electrodes, it may be preferable for certain applications to gold plate the grooved electrode(s) which provide conduction layers. This process may include multiple steps including the initial deposition and evaporation of a layer of titanium (Ti) and gold (Au). A variety of evaporation techniques can be used including electron beam evaporation to deposit a Ti/Au layer onto a substrate formed of a quartz, glass (including borosilicate glass such as Pyrex) and a variety of insulative materials. Another layer of Au or other selected metal can be next deposited by various-processes including electroplating. An electrical current can be applied to coat the electrically conductive surface or Ti/Au layer thereunder with yet another relatively thin layer of material such as Au. The additional electroplating step can deposit a layer of metal such as Au to provide desired surface properties for certain embodiments of the invention such as increased abrasion and wear resistance, corrosion protection, and conductivity. The initial layer evaporated onto the substrate surface may be formed of a material such as Ti/Au which exhibit good or improved adherence to the substrate relative or in comparison to a second or subsequent layer material formed thereon. This provides a foundation for subsequent plating processes when it is desirable to deposit a type of metal to improve corrosion resistance which may have inherently poor adhesion or less adhesion to the underlying substrate material such as glass. In addition to forming the series of mixing grooves, a series of one or more alignment marks can be also etched into the glass to allow alignment of two electrodes relative to a gasket that defines a flow channel therebetween.

Another preferable embodiment of the invention as shown in FIG. 7 provides an electrode evaporation and lift-off process. The metallization of an electrode surface and contacts can be achieved by electron beam evaporation manufacturing process as shown in FIG. 7: A) the quartz surface is again preferably cleaned with hot piranha, B) & C) photoresist is spun and patterned to define the areas to be metallized, D) & E) an adhesion layer of 10 nm of Ta is evaporated onto the wafer, followed by a conductive/catalytic layer of 100 nm of Pt. The evaporation can be carried out using a tilted, rotating wafer chuck-which allows for coating of the entire surface, which can be especially important in the regions where the grooves meet the unetched surface perpendicularly, and F) lift-off of the resist is performed in acetone to leave only the desired regions metallized.

Both electrodes that will constitute a given flow cell device can be preferably fabricated from the same wafer to ensure identical film thicknesses, etch times, etc. This may be important due to a need for symmetric velocity profiles above and below the virtual interface, and therefore identical mixing structures on the opposing grooved surfaces.

Experimental Characterization of Glass Structures:

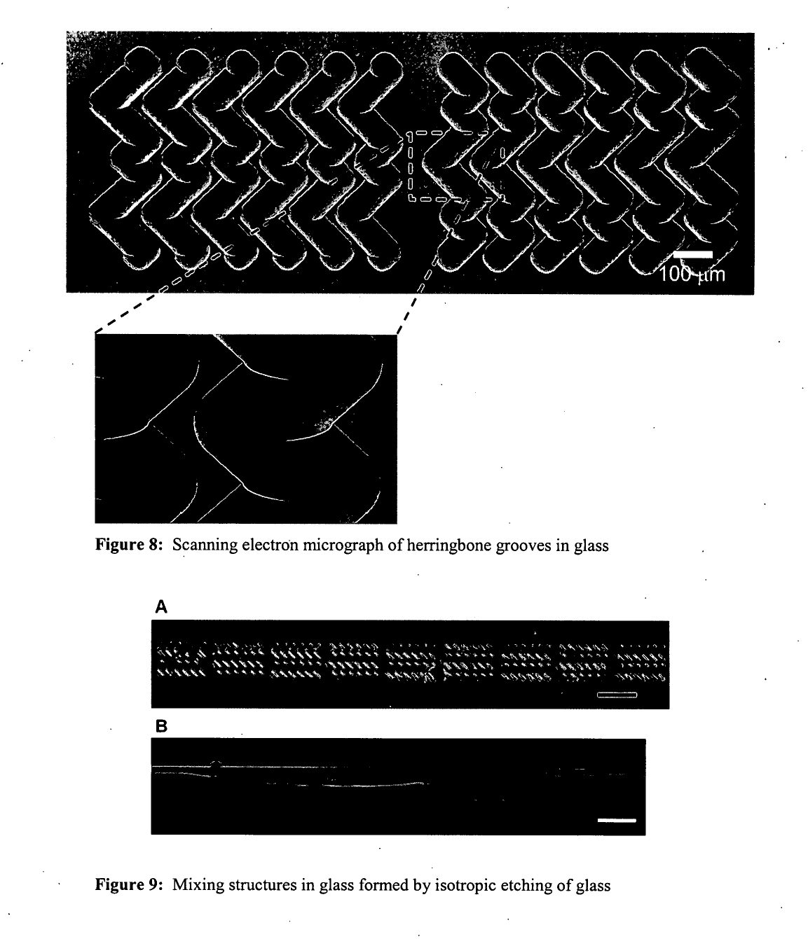

FIG. 8 is a scanning electron micrograph of herringbone grooves formed in glass that may be incorporated into the structures provided in accordance with the invention. The groove structures may be formed by using selected amorphous silicon masks. By implementing appropriate manufacturing techniques and using high quality materials as they become available, the groove structures can be formed without substantial defects.

FIG. 9 illustrates a series of grooves formed as part of a preferable mixing flow cell structure formed by isotropic etching of glass. In part (A), an optical micrograph of the grooves in the glass boundary layer is shown. The image provided shows four and a half cycles of a mixing structure that could be similar in type to the one previously shown in part (B) of FIG. 2 with four rather than 2 units of the SHM running side-by-side (scale bar is 1 mm). As with other embodiments of the invention, this aspect of the invention can be applied to PM²FC (FIG. 2) and other membraneless flow cell designs. In part (B) of FIG. 9, a fluorescence micrograph is illustrated showing the evolution of a narrow stream of fluorescent solution in a 3-D flow generated over the structure shown in part (A). The patterned glass was made the floor of a 120 micrometer-deep microchannel (scale bar is 250 μm).

The optical micrograph of part (A) of FIG. 9 is a pattern similar to that shown in part (B) of FIG. 5. Part (B) of FIG. 9 shows a fluorescence micrograph of a stream of fluorescent solution being stirred into a non-fluorescent stream as it flows in a microchannel over one cycle of the patterned glass shown in part (A) of FIG. 9.

Results from Models:

Heterogeneous chemical reactions at fluid-solid interfaces can pose a particular challenge with regards to mass transfer limitations. The existing solid boundary imposes a zero velocity condition on the fluid. This so called no-slip condition makes convective delivery of the reagents to and from the site of reaction less efficient than in the bulk of the fluid or at a fluid-fluid interface. The SHM design, which generates fluid motion from a solid boundary (a geometrically structured surface, see FIG. 2), provides an unusual tool for controlling the convection of reagents near a reactive boundary. The SHM design can be used for improving of the rates of mass transfer to reactive boundaries in accordance with the principles of the invention.

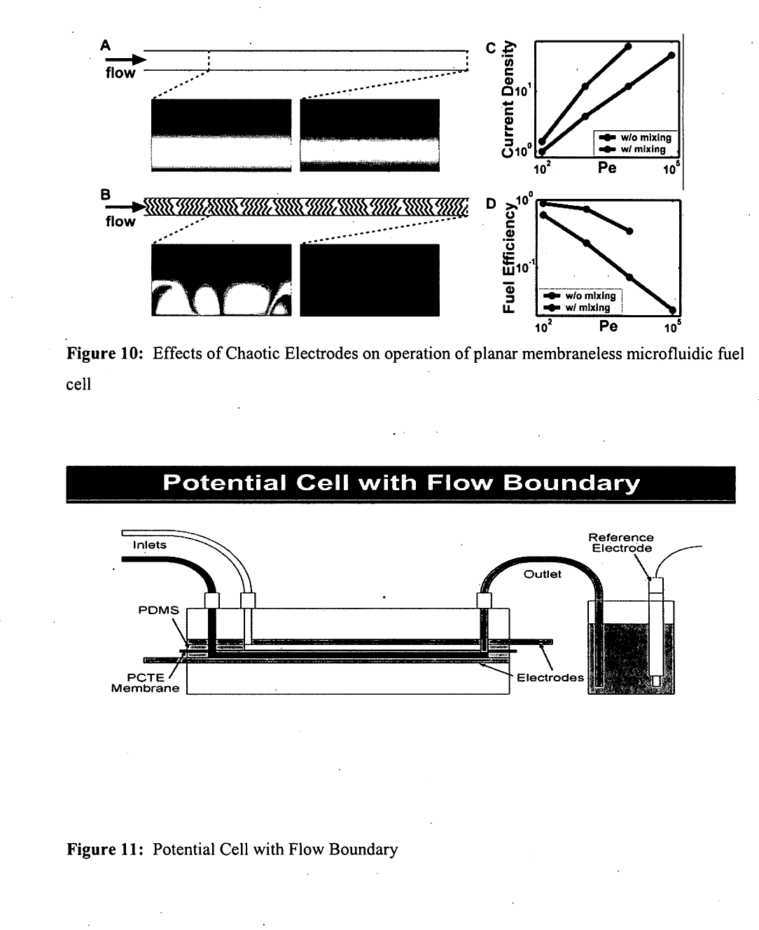

FIG. 10 depicts the effects of chaotic electrodes on the operation of a PM²FC that could be modified in accordance with the invention. The illustrated results were provided from numerical simulation with fast electrode kinetics. In part (A), the evolution of a distribution of fuel in a PM²FC with conventional, flat electrodes is shown. Meanwhile, in part (B), a distribution using chaotic electrodes provided in accordance with a preferable embodiment of the invention is illustrated part (B). In addition, parts (C) and (D) of FIG. 10 plot current density and fuel efficiency, respectively, for conventional electrodes (blue-w/o mixing) and chaotic electrodes (green-w/mixing).

Furthermore, FIG. 10 illustrates the results of a time-dependent finite difference (TDFD) calculation of the evolution of a fuel species as it progresses down an electrochemical cell that mimics the geometry of the PM²FC design. An analytical model of the chaotic flow in the SHM has been employed and validated with bulk mixing experiments (NPP 12). Relative to an unmixed case, the SHM leads to: 1) a substantial increase of the maximum current density (50-200%) at all Peclet numbers (measure of flow speed), as illustrated qualitatively in parts (A) and (B) of FIG. 10, and quantitatively in part (C) in FIG. 10; 2) increased fuel efficiency (100-200%) at all Pe, and 3) improved scaling of both maximum current density and fuel efficiency with Pe, as illustrated in parts (C) and (D) of FIG. 10. Furthermore, part (B) of FIG. 10 illustrates that the SHM can provide spatially selective convection such that efficient mixing occurs within a virtual half-cell without generating substantial cross-over of fuel at the virtual membrane. This suggests that the SHM can play a substantial role in improving performance of transport limited surface reactions in general, and the PM²FC in particular which can be modified in accordance with various aspects of the invention.

It shall be understood that the methods and apparatus provided in accordance with the invention can be used for various applications incorporating both membraneless or PM²FC systems, including those described herein (see FIGS. 4-10) as well as flow structures or fuel cells formed with membranes. These systems can be used for facilitating electrochemical or chemical reactions, dissolving substances within a medium, mixing a fluid or fluids to achieve a desired level of homogeneity, or chemical or protein separations.

Mixing and Chaotic Stirring of Parallel Fluid Streams

Another aspect of the invention is directed to mixing apparatus and methods that accomplish symmetrical stirring mixing between fluid streams or co-flowing laminar flows. Any of the apparatus described above and herein may be configured to passively create a transverse flow component in a fluid flowing within a channel without the use of moving stirring or mixing elements. At the same time, the apparatus can increase rates of mass transfer to reactive boundaries accomplished at least in part by forming topographical structures along a single or pair of microchannel walls or surfaces. For example, the transverse component can be created by grooves defined on a single channel wall or pair of opposing channel walls. The invention can be used in systems where diffusion is the mechanism that primarily controls fluid mixing as is often the case with membraneless fuel cell structures. But it shall be understood that other embodiments of the invention include structures formed with physical membranes which also support chaotic stirring but within separated compartments of the devices.

The term “transverse” can be used to describe a crosswise direction or at angle relative to a direction of a channel.

The term “principal direction” can be used to describe the direction of flow along a flow structure through which the bulk or the majority of the fluid can flow. For example, the principal direction within a channel can be typically defined along the length of the channel, in contrast to across the width of the channel.

The term “transverse flow component” can be used to describe a flow component that is oriented at an angle relative to a particular direction, preferably, relative to the principal direction.

The patterned topography on planar surfaces provided in accordance with the invention herein can be used to generate chaotic flows in contexts other than pressure driven flows in microchannels. For example, chevron-shaped structures on the walls of round pipes and capillaries can provide efficient symmetrically stirred laminar flow or mixing. Thus, in an alternate embodiment of the invention, a fluid unit operation that is dependent upon heat or mass transfer, such as a heat exchanger, may have laminar chaotic flows which flow over opposing planar surfaces that incorporate staggered herringbone designs described elsewhere herein. This symmetrical stirring of laminar co-flowing materials within a flow cell may enhance the rates of diffusion limited reactions at surfaces (e.g., as in electrode reactions, chemical transformations by heterogeneous catalysis, chemical or particulate binding at solid boundaries for sensing, coating, or film growth) and also provide an increase in the rates of heat transfer at the boundary regions. This symmetrical design may also enhance separation processes between co-flowing liquid solutions, as in desalting and solvent extractions.

In another aspect of the invention, an increase in the effective exposed or interfacial area is provided between laminar co-flowing solutions to promote diffusion of components between distinct volumes of the flowing fluids. In a preferable embodiment, this may promote mixing or stirring through diffusion by diverting a portion of the flowing fluids by creating a transverse flow component in the flowing fluid. The transverse flow component may create a “folding effect” so that the effective exposed area through which diffusion of molecular species can occur is increased or, in another sense, the distance over which diffusion must act to eliminate concentration variations is decreased. Such an effect may reduce the rate of dispersion along the flow by carrying unit volumes of the fluid between fast and slow moving regions. As the fluid progresses through a flow cell apparatus, the mixing or stirring of the fluid or fluids can be increased as the diffusion area is increased and, consequently, the time that is required to achieve mixing to a desired homogeneity is reduced.

The concepts of the invention may be preferably applied for use with co-flowing laminar fluids. They may be used advantageously in microfluidic systems wherein the laminar flow is particularly predominant. Fluids flowing in such systems are typically characterized as laminar Poiseuille flows with low Reynolds numbers which can be designed to create a transverse flow component within such flows that are non-turbulent, preferably having a Reynolds number Re that is less than about 2000, preferably, less than 100, more preferably, less than about 12, and even more preferably, less than 5. According to a preferable embodiment, a channel can be formed within a laminar flow cell having a rectangular cross-section with a width and a depth or height. A series of grooves, undulations or protrusions can be formed on at least one channel surface, and in a preferable embodiment they can be symmetrically formed on opposite face surfaces within the channel (mirror images). A pair of fluids (e.g., fuel-hydrogen/oxidant-oxygen) can flow in the channel according to a principal direction along a lengthwise direction of the channel. In alternative embodiments, a microfluidic channel can be formed with a variety of cross-sectional shapes including, but not limited to, rectangular, circular and elliptical.

In some embodiments of the invention, the series of grooves or protrusions can be oriented to form an angle relative to the principal direction (see FIG. 5). The grooves on a channel surface can be constructed and arranged to create an anisotropic response to an applied pressure gradient thereby producing at least one three-dimensional flowpath such as transverse flow component in fluid flowing in a channel. The grooves can be formed as undulations that provide reduced flowing resistance along the valleys of grooves. As a result, the fluid near a channel surface groove can be exposed to reduced flow resistance at or near the valleys creating a transverse flow component. As the fluid flows further along a principal direction, the transverse flow components can be further generated or increase in magnitude through additional grooves defined along channel surface downstream. The resultant effect may create what may be characterized as a circulating or helical flow path (see FIGS. 4 and 10).

Furthermore, the grooves provided in accordance with the invention which are formed on opposing channel surfaces can be oriented at an angle relative to a principal direction, or alternatively offset or traverse to at least a portion of the cross-section of the mixing apparatus. The series of grooves may be periodically arranged to form a set or series of repeating chevron shapes. The chevron-shaped structures herein typically have at least one apex formed with substantially straight lines or edges intersecting at an angle. The term “chevron-shape” can be therefore used to describe or represent a structure having a one or more V-shapes or zigzag shapes. Such structures include those formed by intersecting linear or edges as well as one or more symmetrical and asymmetrical V-shapes.

The herringbone-shaped or chevron-shaped features described herein can be also asymmetric with respect to a lengthwise axis of a channel formed in a flow cell. In preferable embodiments of the invention, the asymmetry of the chevron-shaped features may vary in alternating or in another predetermined fashion. For example, the asymmetry of chevron-shaped grooves in a first set or series of grooves can differ from that of an adjacent-set or series (see FIG. 5). A preferable embodiment further includes a plurality of dual-chevron grooves that includes two peaks as illustrated. A pair of consecutive series or sets of groves may form a cycle of the mixing apparatus. The term “cycle” can refer to a plurality of sets that are sufficient to produce a spiral flow component. Thus, in one embodiment, one cycle refers to a first set of similarly grooves and a second set of similarly shaped grooves. A set of cycles may comprise a plurality of cycles, each cycle comprising sets of shaped features and each cycle may be geometrically distinguishable from another cycle. For example, a set may comprise a first group of chevron-shaped grooves defining a first apex group that are similarly shaped and a second set of chevron-shaped grooves defining a second apex group that are similarly shaped, the second apex group are “offset” from the first apex group such that the apex is displaced from the first group relative to an axis, e.g., the axis along the principal direction. The staggered herringbone and chevron based designs provided herein can create a patterned topography on surfaces of microchannels to offer a general solution for laminar stirring and mixing of fluids within microfluidic systems. The simplicity of its design allows it to be easily manufactured and integrated into microfluidic structures with standard microfabrication techniques. Any of the aforementioned features and patterned or grooved designs can be applied to the structures and methodologies described herein.

Symmetrically Stirred Devices with Membranes

Another aspect of the invention provides planar fuel cells with grooved electrodes that further comprise membranes separating the two-half cells. FIG. 11 illustrates a preferable embodiment in accordance with this aspect of the invention which provides a planar fuel cell formed with a substantially inert, nano-porous barrier in between the two half-cells. A pair of substantially planar grooved electrodes can be oppositely secured together with a membrane positioned or sandwiched in between. A series of gaskets or other sealing structures formed of polymer materials such as polydimethylsiloxane (PDMS) may be positioned between the electrode and the selected membrane. The membrane may be formed of suitable materials such as track-etched polycarbonate (PCTE). The electrode within each half-cell (anode/cathode compartment) can be thus formed with grooved or contoured surfaces (see FIGS. 4, 5 and 10). But due to the additional presence of a physical barrier, the (chaotic) mixing may be confined to each respective single half-cell that results from or is induced by the grooved or patterned electrodes provided in accordance other aspects of the invention herein. In addition, the mixing in each half-cell or compartment may also proceed without requiring alignment of the (top/bottom) pair of grooved electrodes which may be preferred in certain membraneless embodiments of the invention.

The fuel cells or flow structures modified in accordance with this aspect of the invention share many of the same characteristics and benefits as the membraneless embodiments and designs described herein. Both designs with and without physical barriers between the two compartments of the structure are compatible with chaotic stirring. Systems that include a membrane or barrier may support the (dual) flow of liquid fuel and oxidant in the same or distinct electrolyte solution (including those described in U.S. patent application Ser. No. 11/285,509 which is incorporated by reference herein in its entirety) while offering a broad range of chemical compatibility, including applications with dual electrolyte systems. Membrane systems provided herein are also compatible with large area, planar electrodes. The addition of a membrane is a relatively simple additional step that can be added to the fabrication process described elsewhere herein (see FIGS. 6-7) and has a relatively low material cost.

A preferable embodiment of the invention provides fuel cells that are formed with track-etched membranes separating the two half-cells. The track-etched membranes can be formed of polycarbonate or similar materials which have been used as precision membrane filters with closely controlled pore size distribution. Such membranes include commercially available materials such as Nucleopore polycarbonate and Cyclopore polycarbonate/polyester membranes (Whatman Inc., Florham Park, N.J.). The membranes may include pore sizes ranging from 0.02 to 5 μm, and may include straight pores of sub-micrometer diameter traversing its thickness. These track-etched membranes may provide in effect “physical” membranes rather than chemical membranes. These physical membranes or films do not readily adsorb solvents that come in contact therewith on a molecular scale. But rather these membranes used herein may host such solvents in its pore structures. The physical membranes can serve as a flow boundary to effectively block the fluid flow between the anodic and cathodic compartments of a fuel cell. Such membranes may not offer any specific chemical selectivity, but at the same time they do not restrict the chemistry involved with the electrolyte(s) either. Moreover, fuel cells formed with membranes herein can be compatible with all of the applications and relevant chemistries used with membraneless embodiments of the invention described elsewhere herein including those incorporating fuel/oxidant flows in single or dual electrolyte(s) systems. Unlike “chemical” membranes used with conventional fuel cell devices which are films that may adsorb solvents at a molecular scale, the non-adsorbing membranes selected for purposes of the invention herein host or harbors solvents exposed thereto. For example, poly(electrolyte) or polymer electrolyte membranes (proton exchange membranes, PEMs) such as Nafion (DuPont) are common examples of commercially available chemical membranes for fuel cells. While such chemical membranes can offer selectivity, they have also been observed to restrict the chemistry of selected electrolytes. The fuel cells provided in accordance with this aspect of the invention with track-etched membranes can therefore accomplish chaotic stirring to improve mass transfer to electrodes without inhibiting the chemistry of the electrolytes within the structures.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art upon reference to the present disclosure. It is therefore contemplated that the appended claims shall also cover any such modifications, variations and equivalents.

### INCORPORATION BY REFERENCE

All publications, patents, and patent applications mentioned in this specification are herein incorporated by reference in their entirety to the same extent as if each individual publication, patent or patent application was specifically and individually indicated to be incorporated by reference. More specifically, the following non-patent publications (NPP) are herein incorporated by reference in their entirety.
1. Kenis P J A, Ismagilov R F, Takayama S, Whitesides G M, Li S L, White H S: Fabrication inside microchannels using fluid flow. Accounts of Chemical Research. 33:841-847, 2000.
2. Stone H A, Stroock A D, Ajdari A: Engineering flows in small devices: Microfluidics toward a lab-on-a-chip. Annual Review of Fluid Mechanics. 36:381-411, 2004.
3. Ferrigno R, Stroock A D, Clark T D, Mayer M, Whitesides G M: Membraneless vanadium redox fuel cell using laminar flow (vol 124, pg 12930, 2002). Journal of the American Chemical Society. 125:2014-2014, 2003.
4. Choban E R, Markoski L J, Wieckowski A, Kenis P J A: Microfluidic fuel cell based on laminar flow. Journal of Power Sources. 128:54-60, 2004.
5. Cohen J L, Volpe D J, Westly D A, Pechenik A, Abruna H D: A dual electrolyte H-2/O-2 planar membraneless microchannel fuel cell system with open circuit potentials in excess of 1.4 V. Langmuir. 21:3544-3550, 2005.
6. Cohen J L, Westly D A, Pechenik A, Abruna H D: Fabrication and preliminary testing of a planar membraneless microchannel fuel cell. Journal of Power Sources. 139:96-105, 2005.
7. Yeom J, Mozsgai G Z, Flachsbart B R, Choban E R, Asthana A, Shannon M A, Kenis R: Microfabrication and characterization of a silicon-based millimeter scale, PEM fuel cell operating with hydrogen, methanol, or formic acid. Sensors and Actuators B-Chemical. 107:882-891, 2005.
8. Kenis P J A, Ismagilov R F, Whitesides G M: Microfabrication inside Capillaries Using Multiphase Laminar Flow Patterning. Science. 285:83-85, 1999.
9. Kamholz A E, Weigl B H, Finlayson B A, Yager P: Quantitative Analysis of Molecular Interaction in a Microfluidic Channel: The T-Sensor. Analytical Chemistry. 71:5340-5347, 1999.
10. Weigl B H, Yager P: Microfluidic Diffusion-Based Separation and Detection. Science. 283:346, 1999.
11. Stroock A D, Dertinger S K W, Ajdari A, Mezic I, Stone H A, Whitesides G M: Chaotic mixer for microchannels. Science. 295:647-651, 2002.
12. Stroock A D, McGraw G J: Investigation of the staggered herringbone mixer with a simple analytical model. Philosophical Transactions of the Royal Society (Series A: Mathematical, Physical and Engineering Sciences). 362:971-986, 2004.
13. Stroock A D, Dertinger S K, Whitesides G M, Ajdari A: Patterning flows using grooved surfaces. Analytical Chemistry. 74:5306-5312, 2002.
14. Kirtland J D, McGraw G J, Stroock A D: Mass Transfer to Reactive Boundaries from Steady Three-Dimensional Flows in Microchannels. Physics of Fluids. 18, 073602, 2006.

What is claimed is:

1. An apparatus for symmetrically stirred laminar flows comprising:
a flow cell formed with at least one microfluidic channel for supporting at least one fluid laminar flow therethrough in a principal direction, wherein the microfluidic channel is formed between a pair of opposing planar surfaces each having at least one symmetrical groove defined thereon along a plane of symmetry running substantially parallel with opposing planar surfaces, the at least one groove having a first orientation that forms an angle relative to the principal direction.

2. The apparatus as recited in claim 1, wherein the symmetrical groove is a round bottomed groove.

3. The apparatus as recited in claim 1, wherein the symmetrical groove is a flat bottomed groove.

4. The apparatus are recited in claim 1, wherein each of the opposing planar surfaces include a first series of chevron-shaped grooves formed with two apex points to provide dual or double chevron-shaped structures.

5. The apparatus are recited in claim 4, further comprising a second series of non-identical chevron-shaped grooves relative to the first series on the opposing planar surfaces having formed with two apex points.

6. The apparatus as recited in claim 1, further comprising a membrane positioned within the flow cell separating the microfluidic channel into two compartments to sustain separate symmetrically stirred laminar flows within each of the two compartments.

7. A laminar flow fuel cell comprising:
a pair of electrodes each formed with a substantially planar surface facing each other that defines a channel therebetween, the channel including two opposing channel surfaces to support two laminar co-flowing fluids therethrough along a principal direction, wherein each opposing channel surface has a plurality of chevron-shaped protrusions formed in at least a portion of the channel surface so that each chevron-shaped groove or protrusion has at least one apex that defines an angle.

8. The laminar flow fuel cell as recited in claim 7, wherein each of the chevron-shaped protrusions are formed with two apex points to provide dual or double chevron-shaped structures.

9. The laminar flow fuel cell as recited in claim 8, wherein the channel includes a first set of dual chevron-shaped grooves or protrusions and a second set of dual chevron-shaped protrusions.

10. The laminar flow fuel cell as recited in claim 9, wherein the apex of each of the first set of dual chevron-shaped grooves or protrusions are aligned offset relative to the apex of each of the second set of dual chevron-shaped protrusions.

11. The laminar flow cell as recited in claim 7, wherein the two opposing channel surfaces are substantial mirror images when facing each other.

12. The laminar flow cell as recited in claim 1, wherein the two laminar co-flowing fluids are a fuel and an oxidant.

13. The laminar flow cell as recited in claim 12, wherein the fuel and the oxidant are included a single electrolyte solution.

14. The laminar flow cell as recited in claim 12, wherein the fuel and the oxidant are included a dual electrolyte solution.

15. A method for increasing rates of mass transfer to reactive boundary surfaces comprising the steps of:
providing a flow cell structure having two opposing surfaces with a plurality of substantially linear grooves formed with at least one apex that are oriented at an angle relative to a principal direction, wherein at least some portions of the grooves are formed substantially parallel and periodically spaced from each other; and
directing two co-flowing fluids to flow along the opposing surfaces thereby forming a diffusive membrane between the fluids so that diffusion can occur as between the two co-flowing fluids, each fluid flowing adjacent to an opposing surface having a Reynolds number that is less than about 100, wherein at least a portion of the co-flowing fluids are stirred luminary in a direction substantially transverse relative to the principal direction.

16. The method as recited in claim 15, wherein the flow cell structure includes a membrane positioned in between the two opposing surfaces thereby forming two compartments to maintain the co-flowing fluids physically separate.

17. The method as recited in claim 16, wherein the membrane is a track-etched membrane.

18. The method as recited in claim 17, wherein the track-etched membrane is formed of a polycarbonate material.

19. The method as recited in claim 15, wherein the two opposing surfaces are substantial mirror images to each other.

20. The method as recited in claim 15, wherein the substantially linear grooves are chevron-shaped grooves formed with two apex points to provide dual chevron-shaped structures.
